(19) United States
(12) Patent Application Publication
(10) Pub. No.: US 2005/0113470 A1
(43) Pub. Date: May 26, 2005

(54) Mixtures of hydrofluorcarbons and acids as foam blowing agents

(75) Inventors: Zhen Zhu, Williamsville, NY (US); David J. Williams, East Amherst, NY (US); Mary C. Bogdan, Buffalo, NY (US)

Correspondence Address: Colleen D. Szuch, Esq.;Honeywell Corporation, Law Department, AB2, P.O. Box 2245, Morristown, NJ, 07962-2245, US

(73) Assignee: Honeywell Corporation

(21) Appl. No.: 10/721,611

(22) Filed: Nov. 25, 2003

(51) Int. Cl. C08J 9/00

(52) U.S. Cl. 521/50; 252/182.22

(57) ABSTRACT

A method of preparing polyurethane or polyisocyanurate from compositions comprising reacting and foaming a mixture of at least one polyol and isocyanate which react to form polyurethane or polyisocyanurate foams in the presence of a blowing agents which comprises: a hydrofluorocarbon or at least one compound selected from the group consisting of: propane, n-butane, isobutene, n-pentane, isopentane, neopentane, cyclopentane, acetone, dimethyl ether, and inert gases; an acid; and, optionally, water.

### BACKGROUND OF THE INVENTION

1. Field of the Invention

The present invention relates to mixtures of a hydrofluorocarbon (e.g., 1,1,1,3,3-pentafluoropropane (“HFC-245fa”)), a carboxylic, dicarboxylic or hydroxy acid, (e.g., formic acid) and optionally, water. More particularly, the invention provides compositions of HFC-245fa, formic acid and, optionally, water that are environmentally desirable for use as blowing agents for polymer foam.

2. Discussion of the Background Art

The class of foams known as low density rigid polyurethane or polyisocyanurate foam has utility in a wide variety of insulation applications including, but not limited to, roofing systems, building panels, refrigerators and freezers. Polyurethane and polyisocyanurate foams are manufactured by reacting an organic polyisocyanate with a polyol or mixture of polyols, in the presence of a volatile blowing agent or a chemical precursor that produces gas via chemical reaction. The volatile blowing agent is vaporized by the heat liberated during the reaction of isocyanate and polyol causing the polymerizing mixture of foam. This reaction and foaming process may be enhanced through the use of various additives such as catalysts, surfactants, compatibilizers, flame retardants, and other additives that serve to control the reaction rate of the mixture, to control and adjust cell size, to stabilize the foam structure during formation, or to optimize the physical and flammability properties of the final foam product.

The use of a fluorocarbon as the preferred blowing agent in insulating foam applications is based in part on the resulting k-factor associated with the foam produced. K-factor is a measure of the thermal conductivity of the foam and is defined as the rate of transfer of heat through one square foot of a one inch thick material in one hour where there is a difference of one degree Fahrenheit perpendicularly across the two surfaces of the material.

Fluorocarbons act not only as blowing agents by virtue of their volatility, but also are encapsulated or entrained in the closed cell structure of the rigid foam and are the major contributor to the low thermal conductivity properties of rigid urethane foams. Foams made with chlorofluorocarbon blowing agents such as trichlorofluoromethane (“CFC-11”) and hydrochlorofluorocarbons blowing agents such as 1,1-dichloro-1-fluoroethane (“HCFC-141 b”) offer excellent thermal insulation, due in part to the very low vapor phase thermal conductivity of CFC-11 and HCFC-141b, and are therefore used widely in insulation applications.

However, the release of certain fluorocarbons, most notably chlorofluorocarbons (“CFCs”) and hydrochlorofluorocarbons (“HCFCs”), to the atmosphere is now recognized as contributing to the depletion of the stratospheric ozone layer. In view of the environmental concerns with respect to CFCs and HCFCs, the use of CFC-11 has been phased out and HCFC-141b is in the process of being phased out and replaced by the zero ozone depletion potential materials such as hydrofluorocarbons (“HFCs”), hydrocarbons, CO₂ produced by the reaction of water with isocyanate (hereafter referred to as “water”), and other materials.

Among the more popular zero ozone depletion potential materials, water is not an optimal blowing agent because foam produced from this blowing agent lacks the same degree of thermal insulation efficiency and dimensional stability as foams made with the CFC or HCFC blowing agents. Formic acid reacts with isocyanate to generate equal molar quantities of CO, CO₂ and polyurea. Compared with water, this reaction results in twice the number of moles of gas per moles of reactant, thereby creating less of the undesirable urea linkage per mole of gas generated, improving foam performance. Foam produced using formic acid as the blowing agent, however, still lacks the same degree of thermal insulation efficiency compared to foam made with the CFC or HCFC blowing agents.

The hydrocarbon blowing agents are extremely flammable and therefore less desirable. Because rigid polyurethane foams must comply with building code or other regulations, foams expanded with a hydrocarbon blowing agent often require the addition of relatively high levels of expensive flame retardant materials to meet these regulations. Also, hydrocarbon blowing agents are classified as volatile organic compounds (VOC).

Hydrofluorocarbons, and especially 1,1,1,3,3-pentfluoropropane (HFC-245fa) offer many of the advantages of the CFC and HCFC blowing agents, including non-flammability, low vapor phase thermal conductivity, safety, and ease of use, but because of the absence of chlorine on the molecule do not contribute to the depletion of the Earth's ozone layer.

In order to optimize the overall performance of foam, industry has begun to explore mixtures or blends of blowing agents, many of which contain hydrofluorocarbons of particular interest are mixtures containing a hydrofluorocarbon and one or more non-fluorocarbons, all of zero ozone depletion potential. Such mixtures are the subjects of this invention.

The present invention provides blowing agent compositions that are environmentally safe substitutes for CFCs and HCFCs blowing agents, which produce rigid polyurethane and polyisocyanurate foams with unexpectedly good physical properties.

Moreover, the polyol preblends containing the compositions of the present invention have reduced vapor pressure compared to the polyol preblend containing HFC-245fa blowing agent alone or containing HFC-245fa and water. Reduced polyol blend vapor pressure is an important safety consideration since it is common for these polyol blends to be supplied to the end user in drums. Excessive pressure in the drum can result in unsafe conditions during transportation, handling, and opening of the drums, and in extreme cases, drum failure.

Foams made with the blowing agent compositions of the present invention exhibit improved properties, such as thermal insulation efficiency, improved foam dimensional stability and compressive strength, when compared to foams made with water or formic acid blowing agents alone or a mixture of HFC-245fa and water.

### SUMMARY OF THE INVENTION

A blowing agent composition comprising: a hydrofluorocarbon or at least one compound selected from the group consisting of: propane, n-butane, isobutene, n-pentane, isopentane, neopentane, cyclopentane, acetone, dimethyl ether, and inert gases; an acid; and, optionally, water. The hydrofluorocarbon is preferably present in an amount between about 1 to 99 weight percent based on the amount of the blowing agent, the acid is present in an amount between about 1 to 99 weight percent based on the amount of the blowing agent, and the water is present in an amount between about 0 to 98 weight percent based on the amount of the blowing agent.

The hydrofluorocarbon is preferably at least one selected from the group consisting of: pentafluoropropane isomers (HFC-245), difluoromethane (HFC-32); difluoroethane isomers (HFC-152); trifluoroethane (HFC-143); tetrafluoroethane isomers (HFC-134); pentafluoroethane isomers (HFC-125); hexafluoropropane isomers (HFC-236); heptafluoropropane isomers (HFC-227); pentafluorobutane isomers (HFC-365); fluoroethane isomers (HFC-161); difluoropropane isomers (HFC-272); trifluoropropane isomers (HFC-263); tetrafluoropropane isomers (HFC-254); fluoropropane isomers (HFC-281); hexafluorobutane isomers (HFC-356); decafluoropentane isomers (HFC-43-10mee); chlorodifluoroethane isomers (HCFC-22); dichlorofluoroethane isomers (HCFC-141b); dichlorotrifluoroethane isomers (HCFC-123); chlorotetrafluoroethane isomers (HCFC-124); perfluoroethane; perfluoropropane; perfluorobutane; perfluorocyclobutane; dichloropropane and difluoropropane.

In place of the hydrofluorocarbon, at least one compound may be selected from the group consisting of: propane, n-butane, isobutene, n-pentane, isopentane, neopentane, cyclopentane, acetone, dimethyl ether, and inert gases. The inert gas is at least one selected from the group consisting of air, nitrogen and carbon dioxide.

The acid is at least one acid selected from the group consisting of: mono functional carboxylic acids, di functional carboxylic acids, and hydroxy acids. The preferred acid is formic acid.

The mono functional carboxylic acid is at least one acid selected from the group consisting of C₁ to C₆ mono functional carboxylic acids. The C₁ to C₆ mono functional carboxylic acids are at least one selected from the group consisting of: formic acid, acetic acid, propionic acid, n-butyric acid, isobutyric acid, n-valeric acid, methylethylacetic acid, trimethylacetic acid (pivalic acid), n-caproic acid, methyl-n-propylacetic acid, 3-methylpentanoic acid, isobutylacetic acid, dimethylethylacetic acid, methylisopropylacetic acid, t-buylacetic acid, etc.

The di functional carboxylic acid is at least one acid selected from the group consisting of: C₁ to C₆ di functional carboxylic acids. The C₁ to C₆ di functional acids are at least one selected from the group consisting of: oxalic acid, malonic acid, succinic acid, glutaric acid, adipic acid, methylsuccinic acid, dimethylmalonic acid, β-methylglutaric acid, ethylsuccinic acid, α,α-dimethylsuccinic acid, isopropylmalonic acid, fumaric acid, maleic acid, etc.

The hydroxy acid is at least one acid selected from the group consisting of: C₁ to C₆ hydroxy acids. The C₁ to C₆ hydroxy acids are at least one selected from the group consisting of: hydroxyformic acid, hydroxyacetic acid, β-hydroxypropionic acid, lactic acid (α-hydroxypropionic acid), glycolic acid, glyceric acid, tartaric acid, malic acid, diglycolic acid, erythronic acid, α-hydroxybutyric acid, γ-hydroxybutyric acid, dl-threo-2,3-dihydroxybutyric acid, dl-erythro-2,3-dihydroxybutyric acid, δ-hydroxyvaleric acid, α-hydroxy-α-methylbutyric acid, β-hydroxyisovaleric acid, 2,3-dihydroxypentanoic acid, α-hydroxycaproic acid, ε-hydroxycaproic acid, α-hydroxy-α-methylvaleric acid, β,β,β-trimethyllactic acid, 2,3-dihydroxyhexanoic acid, citric acid, gluconic acid, etc.

The present invention also includes a method of preparing polyurethane or polyisocyanurate from compositions comprising reacting and foaming a mixture of at least one polyol and isocyanate which react to form polyurethane or polyisocyanurate foams in the presence of a blowing agents which comprises: a hydrofluorocarbon; an acid; and, optionally, water.

The method further comprises reacting the isocyanate with the polyol or mixture of polyols in the presence of the blowing agent and at least one additional additive selected from the group consisting of: catalysts, surfactants, compatibilizers, auxiliary blowing agents, dispersing agents, cell stabilizers, flame retardants, additional polyols, colorants, and other materials normally used in the production of polyurethane or polyisocyanurate foams.

These ingredients are added individually to the reaction mixture by suitable metering equipment or methods or, alternatively and more commonly, the polyurethane or polyisocyanurate foams are formed by the reaction of preblended components. The first component comprises the isocyanate and optionally a surfactant and/or blowing agent, and a second component, which comprises the polyol or polyol mixture and the blowing agent plus optionally at least one additional additive selected from the group consisting of: catalysts, surfactants, auxiliary blowing agents, dispersing agents, compatibilizers, cell stabilizers, flame retardants, additional polyols, colorants, and other materials normally used in the production of polyurethane or polyisocyanurate foams. Alternatively, a third component may be added to the first and second components, wherein the third component comprises at least one additional additive selected from the group consisting of: catalysts, surfactants, auxiliary blowing agents, dispersing agents, compatibilizers, cell stabilizers, flame retardants, additional polyols, colorants and other materials normally used in the production of polyurethane or polyisocyanurate foams.

According to the preferred method according to the present invention, the blowing agent is present in an amount between about 1 to 60 parts by weight of the blowing agent per 100 parts by weight of the polyol. More preferably, the blowing agent is present in an amount of between about 5 to 35 parts by weight of the blowing agent per 100 parts by weight of polyol.

A closed cell foam composition prepared from a polymer foam formulation comprising a blowing agent composition comprising: a hydrofluorocarbon; an acid; and, optionally, water. A premix of a polyol and a blowing agent wherein the blowing agent comprises: a hydrofluorocarbon; an acid; and, optionally, water plus optionally at least one additional additive selected from the group consisting of: catalysts, surfactants, auxiliary blowing agents, dispersing agents, compatibilizers, cell stabilizers, flame retardants, additional polyols, colorants, and other materials normally used in the production of polyurethane or polyisocyanurate foams.

A polyurethane or polyisocyanurate foam formed by the reaction product of isocyanate, at least one polyol and at least one blowing agent, the blowing agent comprising: a hydrofluorocarbon; an acid; and, optionally, water plus optionally at least one additional additive selected from the group consisting of: catalysts, surfactants, auxiliary blowing agents, dispersing agents, compatibilizers, cell stabilizers, flame retardants, additional polyols, colorants, and other materials normally used in the production of polyurethane or polyisocyanurate foams.

### DETAILED DESCRIPTION OF THE PREFERED EMBODIMENT

The present inventors have developed compositions that can help to satisfy the continuing need for substitutes for CFCs and HCFCs. In one embodiment, the present invention provides compositions comprising at least one hydrofluorocarbon (e.g., 1,1,1,3,3-pentafluoropropane [HFC-245fa]), at least one acid (e.g., a carboxylic acid, such as formic acid) and, optionally, water.

Preferably, the present invention provides compositions of HFC-245fa, formic acid and, optionally, water. The compositions of the invention provide environmentally desirable replacements for currently used CFCs and HCFCs since hydrofluorocarbons, carboxylic, dicarboxylic and hydroxy acids, and water all exhibit zero ozone (i.e., stratospheric ozone) depletion potential. Additionally, the compositions of the invention exhibit characteristics that, in some cases, make the compositions more preferred CFC and HCFC substitutes than hydrofluorocarbons, acids or water alone or mixtures of hydrofluorocarbon and water.

More specifically, the invention provides the compositions preferably of from about 1 to about 99 weight percent hydrofluorocarbon (e.g., HFC-245fa), from about 99 to about 1 weight percent acid (e.g., formic acid) and from about 0 to about 98 weight percent water. The preferred, more preferred, and most preferred compositions of the invention are set forth in Table 1. The numerical ranges in Table 1 are to be prefaced by the term “about”.

TABLE 1

| | Preferred | More Preferred | Most Preferred |
|---|---|---|---|
| Components | (wt %) | (wt %) | (wt %) |
| HFC-245fa | 1-99 | 40-95 | 70-90 |
| Formic Acid | 99-1 | 60-5 | 30-10 |
| Water | 98-0 | 20-0 | 5-0 |

The compositions of the invention meet the need in the art for hydrofluorocarbon (HFC) mixtures that have no ozone depletion potential and are nonflammable.

The mixtures containing hydrofluorocarbon in accordance with the present invention are particularly suitable as foam blowing agents since foams blown with hydrofluorocarbon, such as HFC-245fa, have been found to possess low initial and aged thermal conductivity and good dimensional stability, especially at low temperatures. Of particular interest are the compositions that contain formic acid and further contain other zero ozone depleting materials, such as, for example, other hydrofluorocarbons. As used herein blowing agent compositions refer to HFC-245fa or other non-ozone depleting blowing agents, such as for example, other hydrofluorocarbons, e.g., difluoromethane (HFC-32), difluoroethane (HFC-152, HFC-152a), trifluoroethane (HFC-143), tetrafluoroethane (HFC-134, HFC-134a), pentafluoroethane (HFC-125), pentafluoropropane (HFC-245), hexafluoropropane (HFC-236), heptafluoropropane (HFC-227), pentafluorobutane (HFC-365), HFC-32, HFC-161, HFC-272, HFC-263, HFC-254, HFC-281, HFC-356, HFC-43-10mee, perfluoroethane, perfluoropropane, perfluorobutane, perfluorocyclobutane, and difluoropropane. Alternatively, any of propane, n-butane, isobutene, n-pentane, isopentane, neopentane, cyclopentane, acetone, dimethyl ether, and inert gases, e.g., air, nitrogen and carbon dioxide, may be used in place of the hydrofluorocarbon. Where isomerism is possible for the hydrofluorocarbons mentioned above, the respective isomers may be used either singly or in the form of a mixture.

HFC-245fa is a known material and can be prepared by methods known in the art, such as those disclosed in WO 94/14736, WO 94/29251, WO 94/29252 and U.S. Pat. No. 5,574,192, all of which are incorporated herein by their entirety.

The preferred acids according to the present invention can be at least one selected from the group consisting of about C₁ to C₆ mono or di functional carboxylic acids, as well has hydroxy acids. The preferred C₁ to C₆ mono functional acids are at least one selected from the group consisting of: formic acid, acetic acid, propionic acid, n-butyric acid, isobutyric acid, n-valeric acid, methylethylacetic acid, trimethylacetic acid (pivalic acid), n-caproic acid, methyl-n-propylacetic acid, 3-methylpentanoic acid, isobutylacetic acid, dimethylethylacetic acid, methylisopropylacetic acid, t-buylacetic acid, etc. The preferred C₁ to C₆ di functional acids are at least one selected from the group consisting of: oxalic acid, malonic acid, succinic acid, glutaric acid, adipic acid, methylsuccinic acid, dimethylmalonic acid, β-methylglutaric acid, ethylsuccinic acid, α,α-dimethylsuccinic acid, isopropylmalonic acid, fumaric acid, maleic acid, etc. The preferred C₁ to C₆ hydroxy acids are at least one selected from the group consisting of: hydroxyformic acid, hydroxyacetic acid, β-hydroxypropionic acid, lactic acid (α-hydroxypropionic acid), glycolic acid, glyceric acid, tartaric acid, malic acid, diglycolic acid, erythronic acid, α-hydroxybutyric acid, γ-hydroxybutyric acid, dl-threo-2,3-dihydroxybutyric acid, dl-erythro-2,3-dihydroxybutyric acid, δ-hydroxyvaleric acid, α-hydroxy-α-methylbutyric acid, β-hydroxyisovaleric acid, 2,3-dihydroxypentanoic acid, α-hydroxycaproic acid, ε-hydroxycaproic acid, α-hydroxy-α-methylvaleric acid, β,β,β-trimethyllactic acid, 2,3-dihydroxyhexanoic acid, citric acid, gluconic acid, etc.

Another aspect of the present invention is the greatly reduced vapor pressure of polyol preblends containing the blowing agent compositions of the present invention. The polyol preblends containing hydrofluorocarbon such as HFC-245fa often exhibit vapor pressure higher than what is considered safe for shipping in standard shipping containers, most commonly drums. The polyol preblends containing the preferred compositions of the present invention show at least about 35 percent vapor pressure reduction, compared to polyol preblends containing only HFC-245fa. In certain preferred embodiments, the polyol preblends containing the blowing agent compositions of the present invention show greater than about 75 percent vapor pressure reduction than the polyol preblends containing HFC-245fa. Therefore, the polyol preblends containing the blowing agent compositions of the present invention can be safely shipped in standard shipping containers.

Additionally, the thermal conductivity, or k-factor of foams prepared using the compositions of the invention is lower, hence superior, when compared to the thermal conductivity of foam prepared using formic acid or water alone, or mixtures of hydrofluorocarbon and water as the blowing agent. Improved dimensional stability and compressive strength are also observed.

In another process embodiment, the compositions of the invention are used in a method for producing polyurethane and polyisocyanurate foams. Such method is any of the methods well known in the art such as those described in “Polyurethanes Chemistry and Technology,” Volumes I and II, Saunders and Frisch, 1962, John Wiley and Sons, New York, N.Y. In general, the method comprises preparing polyurethane or polyisocyanurate foams by combining an isocyanate, a polyol or mixture of polyols, a blowing agent or mixture of blowing agents, and other materials, such as catalysts, surfactants, and, optionally, flame retardants, colorants, or other additives. The blowing agent or agents employed shall be a mixture of the compositions of the present invention.

It is convenient in many applications to provide the components for polyurethane or polyisocyanurate foams in preblended formulations. Most typically, the foam formulation is preblended into two components. The isocyanate and, optionally, certain surfactants and blowing agents comprise the first component, commonly referred to as the “A” or “iso” component. The polyol or polyol mixture, surfactant, catalysts, blowing agents, flame retardant, and other isocyanate reactive components comprise the second component, commonly referred to as the “B”, or “polyol” or “resin” component. Accordingly, polyurethane or polyisocyanurate foams are readily prepared by bringing together the A and B components either by hand mix for small preparations and, preferably, machine mix techniques to form blocks, slabs, laminates, pour-in-place panels and other items, spray applied foams, froths, and the like. Optionally, other ingredients, such as fire retardants, colorants, auxiliary blowing agents, and even other polyols can be added as a third stream to the mix head or reaction site. Most conveniently, however, they are all incorporated into one B component as described above.

Dispersing agents, cell stabilizers, and surfactants may also be incorporated into the blowing agent mixture. Surfactants are added to serve as cell stabilizers. Some representative materials are sold under the names of DC-193, B-8404, and L-5340 which are, generally, polysiloxane polyoxyalkylene block co-polymers such as those disclosed in U.S. Pat. Nos. 2,834,748, 2,917,480, and 2,846,458, all of which are incorporated herein by reference. Other optional additives for the blowing agent mixture may include flame retardants such as tris(2-chloroethyl)phosphate, tris(2-chloropropyl)phosphate, tris(2,3-dibromopropyl)-phosphate, tris(1,3-dichloropropyl)phosphate, various halogenated aromatic compounds, and the like.

Generally speaking, the amount of blowing agent present in the blended mixture is dictated by the desired foam densities of the final polyurethane or polyisocyanurate foam product. The polyurethane foam produced can vary in density from about 0.5 pound per cubic foot to about 40 pounds per cubic foot, preferably from about 1.0 to about 20.0 pounds per cubic foot, and most preferably from about 1.5 to about 6.0 pounds per cubic foot for rigid polyurethane foams. The density obtained is a function of several factors, including how much blowing agent, or blowing agent mixture, is present in the A and/or B components, or that is added at the time the foam is prepared.

The proportions in parts by weight of the total blowing agent or blowing agent blend can fall within the range of from about 1 to about 60 parts of blowing agent per 100 parts of polyol. Preferably a combined amount from about 5 to about 35 parts by weight of HFC-245fa, formic acid and/or water per 100 parts by weight of polyol are used.

Any organic polyisocyanate can be employed in polyurethane or polyisocyanurate foam synthesis inclusive of aliphatic and aromatic polyisocyanates. Preferred as a class are the aromatic polyisocyanates. Preferred polyisocyanates for rigid polyurethane or polyisocyanurate foam synthesis are the polymethylene polyphenyl isocyanates, particularly the mixtures containing from about 30 to about 85 percent by weight of methylenebis(phenyl isocyanate) with the remainder of the mixture comprising the polymethylene polyphenyl polyisocyanates of functionality higher than 2.

Typical polyols used in the manufacture of rigid polyurethane foams include, but are not limited to, aromatic amino-based polyether polyols such as those based on mixtures of 2,4- and 2,6-toluenediamine condensed with ethylene oxide and/or propylene oxide. These polyols find utility in pour-in-place molded foams. Another example is aromatic alkylamino-based polyether polyols such as those based on ethoxylated and/or propoxylated aminoethylated nonylphenol derivatives. These polyols generally find utility in spray applied polyurethane foams. Another example is sucrose-based polyols such as those based on sucrose derivatives and/or mixtures of sucrose and glycerine derivatives condensed with ethylene oxide and/or propylene oxide. These polyols generally find utility in pour-in-place molded foams.

Examples of polyols used in polyurethane modified polyisocyanurate foams include, but are not limited to, aromatic polyester polyols such as those based on complex mixtures of phthalate-type or terephthalate-type esters formed from polyols such as ethylene glycol, diethylene glycol, or propylene glycol. These polyols are used in rigid laminated boardstock, and may be blended with other types of polyols such as sucrose based polyols used in refrigerators/freezer foam application, or mannich base polyols used in spray foam applications.

Catalysts used in the manufacture of polyurethane foams are typically tertiary amines including, but not limited to, N-alkylmorpholines, N-alkylalkanolamines, N,N-dialkylcyclohexylamines, and alkylamines where the alkyl groups are methyl, ethyl, propyl, butyl and the like and isomeric forms thereof, as well as heterocyclic amines. Typical, but not limiting, examples are triethylenediamine, tetramethylethylenediamine, bis(2-dimethylaminoethyl)ether, triethylamine, tripropylamine, tributylamine, triamylamine, pyridine, quinoline, dimethylpiperazine, piperazine, N,N-dimethylcyclohexylamine, N-ethylmorpholine, 2-methylpiperazine, N,N-dimethylethanolamine, tetramethylpropanediamine, methyltriethylenediamine, and mixtures thereof.

Optionally, non-amine polyurethane catalysts are used. Typical of such catalysts are organometallic compounds of lead, tin, titanium, antimony, cobalt, aluminum, mercury, zinc, nickel, copper, manganese, zirconium, and mixtures thereof. Exemplary catalysts include, without limitation, lead 2-ethylhexoate, lead benzoate, ferric chloride, antimony trichloride, and antimony glycolate. A preferred organo-tin class includes the stannous salts of carboxylic acids such as stannous octoate, stannous 2-ethylhexoate, stannous laurate, and the like, as well as dialkyl tin salts of carboxylic acids such as dibutyl tin diacetate, dibutyl tin dilaurate, dioctyl tin diacetate, and the like.

In the preparation of polyisocyanurate foams, trimerization catalysts are used for the purpose of converting the blends in conjunction with excess A component to polyisocyanurate-polyurethane foams. The trimerization catalysts employed can be any catalyst known to one skilled in the art including, but not limited to, glycine salts and tertiary amine trimerization catalysts, alkali metal carboxylic acid salts, and mixtures thereof. Preferred species within the classes are potassium acetate, potassium octoate, and N-(2-hydroxy-5-nonylphenol)methyl-N-methylglycinate.

The components of the composition of the invention are known materials that are commercially available or may be prepared by known methods. Preferably, the components are of sufficiently high purity so as to avoid the introduction of adverse influences on blowing agent properties of the system.

Additional components may be added to tailor the properties of the compositions of the invention as needed. By way of example, stabilizers and other materials may be added to enhance the properties of the compositions of the invention.

The present invention is more fully illustrated by the following, non-limiting examples.

### EXAMPLES 1-5

In examples 1-5, five foams (“Experiment 1”, “Experiment 2”, “Experiment 3”, “Experiment 4” and “Experiment 5”) are prepared. In general the formulations used to prepare these foams are described in Table 2.

TABLE 2

| Component (parts | | | | | |
|---|---|---|---|---|---|
| by weight) | Exp. 1 | Exp. 2 | Exp. 3 | Exp. 4 | Exp. 5 |
| Polyether Polyol 1 | 67.8 | 67.8 | 67.8 | 67.8 | 67.8 |
| Polyester Polyol | 20.0 | 20.0 | 20.0 | 20.0 | 20.0 |
| Amine Polyol | 7.6 | 7.6 | 7.6 | 7.6 | 7.6 |
| Polyether Polyol 2 | 4.6 | 4.6 | 4.6 | 4.6 | 4.6 |
| Surfactant | 1.0 | 1.0 | 1.0 | 1.0 | 1.0 |
| Catalyst | 1.8 | 1.8 | 1.8 | 1.8 | 1.8 |
| Flame Retardant | 2.80 | 3.80 | 5.60 | 6.50 | 5.80 |
| Water | 0.5 | 0.5 | 0.5 | 0.5 | 0.5 |
| Formic Acid | 35.5 | 26.6 | 17.8 | 8.9 | 0 |
| HFC-245fa | 0 | 1.5 | 3.1 | 4.6 | 6.1 |
| Isocyanate¹ | 145.6 | 154.8 | 164.6 | 174.3 | 184.1 |
| Index | 110 | 110 | 110 | 110 | 110 |

¹Isocyanate - PMDI: polymeric methylene bis diphenyl isocyanate Index is the stoichiometric ratio of isocyanate to polyol (plus other ingredients that react with isocyanate) in the formulation

The same general procedure commonly referred to as “handmixing” is used to prepare all foams. A master batch of premix of polyols, surfactant, catalysts, flame retardant and water is prepared in the proportions indicated in Table 2 to insure that all of the foams in a given series are made with the same master batch of premix. The premix is blended in a one-gallon paint can, and stirred at about 1500 rpm with a Conn 2″ diameter ITC mixer until a homogenous blend is achieved.

When mixing is complete, the can containing the mix is covered and placed in a refrigerator controlled at 50° F. The foam blowing agent or pre-blended pair of blowing agents for experiment 1-5 is also stored in pressure bottles and/or glass bottle at 50° F. The isocyanate component is kept in sealed containers at 70° F.

For the individual foam preparations, an amount of B-component equal to the formulation weight is weighted into a 32 oz. metal can preconditioned at 50° F. The required amounts of the blowing agent blend, also pre-conditioned to 50° F. are added to the B-component. The contents are stirred for two-minutes with a Conn 2″ ITC mixing blade turning at about 1000 rpm. Following this, the mixing vessel and contents are reweighed. If there is a weight loss, the blended blowing agents are added to make up the loss. The contents are then stirred for an additional 30 seconds, and the can replaced in the refrigerator.

After the contents have cooled again to 50° F., approximately 10 minutes, the mixing vessel is removed from refrigerator and taken to the mixing station. A pre-weighted portion of A-component, isocyanate, is added quickly to the B-component, the ingredients are mixed for 10 seconds using a Conn 2″ diameter ITC mixing blade at 3000 rpm and poured into a 8″×8″×4″ cardboard cake box and allowed to rise. Cream, initiation, gel and tack free times are recorded for the individual polyurethane foam samples.

The foams are allowed to cure in the boxes at room temperature for at least 24 hours. After curing, the blocks are trimmed to a uniform size and the foams performance are tested. The results are displayed in Table 3.

In addition, the vapor pressures of polyol premix containing the same compositions of blowing agent as indicated in Table 2 are tested. A master batch of premix of polyols, surfactant, catalysts, flame retardant and water, is prepared and mixed to ensure homogenous blend in the proportions indicated in Table 2. The resin is added to a 3-ounce Fischer-Porter tube, chilled to 10° C. and the required amounts of the blowing agents added. The final liquid level height is about 80% of the container. The system is sealed with a pressure gauge attached to the top of the system. The vapor pressure assembly is heated to the test temperature and well mixed. The system is then placed in a constant temperature oven or bath until a stable reading is achieved. When a stable vapor pressure reading is obtained, it is recorded as static vapor pressure. The sample is then inverted 10 times and the vapor pressure is recorded as dynamic vapor pressure. The results are also displayed in Table 3.

TABLE 3

| Blowing Agent (pbw) | Expt 1 | Expt 2 | Expt 3 | Expt 4 | Expt 5 | HFC-245fa/Water |
|---|---|---|---|---|---|---|
| Formic Acid | 35.5 | 26.6 | 17.8 | 8.9 | 0.0 | 35.5 |
| HFC-245fa | 0.0 | 1.5 | 3.1 | 4.6 | 6.1 | 2 |
| Dynamic Vapor | | | | | | |
| Pressure (psi) | | | | | | |
| 60 F. | 6.7 | 0.4 | 0.0 | 0.9 | −0.1 | |
| 80 F. | 13.6 | 3.9 | 3.5 | 0.8 | 0.2 | |
| 100 F. | 20.1 | 10.2 | 6.9 | 4.2 | 0.5 | |
| 120 F. | 28.8 | 18.4 | 13.3 | 7.3 | 1.6 | 28.0 |
| Foam Performance | | | | | | |
| Initial K-factor (BTU | | | | | | |
| in/hr ft²° F.) | | | | | | |
| 40 F. | 0.1327 | 0.1381 | 0.1326 | 0.1524 | 0.1780 | |
| 75 F. | 0.1488 | 0.1553 | 0.1597 | 0.1696 | 0.1952 | 0.1579 |
| 110 F. | 0.1672 | 0.1724 | 0.1766 | 0.1864 | 0.2119 | |
| Compressive strength | | | | | | |
| Parallel | 28.1 | 26.8 | 32.7 | 24.8 | 18.3 | 26.9 |
| Perpendicular | 20.7 | 21.3 | 20.1 | 18.1 | 13.8 | 9.0 |
| Dimensional stability | 0.055 | −0.371 | −1.026 | −0.149 | −0.734 | −0.370 |
| (28 days at −29 C., V %) | | | | | | |

The examples demonstrate that the vapor pressure of these polyol blends can be reduced using the blowing agent compositions of the present invention, when compared to the polyol preblend containing HFC-245fa blowing agent alone. The polyol preblends containing the compositions of the present invention show at least about 35 to about 75 percent vapor pressure reduction compared to the polyol preblends containing HFC-245fa, as shown in Table 3.

As can be seen from the results in Table 3, the use of a composition of the present invention as a blowing agent results in relatively an improvement of k-factor, dimensional stability and compressive strength, when compared to the foam prepared with just the formic acid or water alone, or mixtures of HFC-245fa and water.

The foregoing description and examples have been set forth merely to illustrate the present invention and are not intended to be limiting. Since modifications of the disclosed embodiments incorporating the spirit and substance of the invention may occur to persons skilled in the art, the invention should be construed broadly to include all variation falling within the scope of the appended claims and equivalents thereof.

1. A blowing agent composition comprising:
a hydrofluorocarbon or at least one compound selected from the group consisting of: propane, n-butane, isobutene, n-pentane, isopentane, neopentane, cyclopentane, acetone, dimethyl ether, and inert gases; an acid; and
optionally, water.

2. The blowing agent according to claim 1, wherein said hydrofluorocarbon is present in an amount between about 1 to 99 weight percent based on the amount of said blowing agent, said acid is present in an amount between about 1 to 99 weight percent based on the amount of said blowing agent, and said water is present in an amount between about 0 to 98 weight percent based on the amount of said blowing agent.

3. The blowing agent according to claim 2, wherein said hydrofluorocarbon is present in an amount between about 40 to 95 weight percent based on the amount of said blowing agent, said acid is present in an amount between about 5 to 60 weight percent based on the amount of said blowing agent, and said water is present in an amount between about 0 to 20 weight percent based on the amount of said blowing agent.

4. The blowing agent according to claim 3, wherein said hydrofluorocarbon is present in an amount between about 70 to 90 weight percent based on the amount of said blowing agent, said acid is present in an amount between about 10 to 30 weight percent based on the amount of said blowing agent, and said water is present in an amount between about 0 to 5 weight percent based on the amount of said blowing agent.

5. The blowing agent according to claim 1, wherein said hydrofluorocarbon is at least one selected from the group consisting of: pentafluoropropane isomers (HFC-245), difluoromethane (HFC-32); difluoroethane isomers (HFC-152); trifluoroethane (HFC-143); tetrafluoroethane isomers (HFC-134); pentafluoroethane isomers (HFC-125); hexafluoropropane isomers (HFC-236); heptafluoropropane isomers (HFC-227); pentafluorobutane isomers (HFC-365); fluoroethane isomers (HFC-161); difluoropropane isomers (HFC-272); trifluoropropane isomers (HFC-263); tetrafluoropropane isomers (HFC-254); fluoropropane isomers (HFC-281); hexafluorobutane isomers (HFC-356); decafluoropentane isomers (HFC-43-10mee); chlorodifluoroethane isomers (HCFC-22); dichlorofluoroethane isomers (HCFC-141 b); dichlorotrifluoroethane isomers (HCFC-123); chlorotetrafluoroethane isomers (HCFC-124); perfluoroethane; perfluoropropane; perfluorobutane; perfluorocyclobutane; dichloropropane and difluoropropane.

6. The blowing agent according to claim 1, wherein said hydrofluorocarbon is 1,1,1,3,3-pentafluoropropane (HFC-245fa).

7. The blowing agent according to claim 1, wherein said acid is at least one acid selected from the group consisting of: mono functional carboxylic acids, di functional carboxylic acids, and hydroxy acids.

8. The blowing agent according to claim 7, wherein said mono functional carboxylic acid is at least one acid selected from the group consisting of: C₁ to C₆ mono functional carboxylic acids.

9. The blowing agent according to claim 8, wherein said C₁ to C₆ mono functional carboxylic acids are at least one selected from the group consisting of: formic acid, acetic acid, propionic acid, n-butyrice acid, isobutyric acid, n-valeric acid, methylethylacetic acid, trimethylacetic acid (pivalic acid), n-caproic acid, methyl-n-propylacetic acid, 3-methylpentanoic acid, isobutylacetic acid, dimethylethylacetic acid, methylisopropylacetic acid, and t-buylacetic acid.

10. The blowing agent according to claim 7, wherein said di functional carboxylic acid is at least one acid selected from the group consisting of: C₁ to C₆ di functional carboxylic acids.

11. The blowing agent according to claim 10, wherein said C₁ to C₆ di functional acids are at least one selected from the group consisting of:
oxalic acid, malonic acid, succinic acid, glutaric acid, adipic acid, methylsuccinic acid, dimethylmalonic acid, β-methylglutaric acid, ethylsuccinic acid, α,α-dimethylsuccinic acid, isopropylmalonic acid, fumaric acid, and maleic acid.

12. The blowing agent according to claim 7, wherein said hydroxy acid is at least one acid selected from the group consisting of: C₁ to C₆ hydroxy acids.

13. The blowing agent according to claim 12, wherein said C₁ to C₆ hydroxy acids are at least one selected from the group consisting of: hydroxyformic acid, hydroxyacetic acid, β-hydroxypropionic acid, lactic acid (α-hydroxypropionic acid), glyoic acid, glyceric acid, tartaric acid, malic acid, diglycolic acid, erythronic acid, α-hydroxybutyric acid, γ-hydroxybutyric acid, dl-threo-2,3-dihydroxybutyric acid, dl-erythro-2,3-dihydroxybutyric acid, α-hydroxyvaleric acid, α-hydroxy-α-methylbutyric acid, β-hydroxyisovaleric acid, 2,3-dihydroxypentanoic acid, α-hydroxycaproic acid, ε-hydroxycaproic acid, α-hydroxy-α-methylvaleric acid, β,β,β-trimethyllactic acid, 2,3-dihydroxyhexanoic acid, citric acid, and gluconic acid.

14. The blowing agent according to claim 1, wherein said acid is formic acid.

15. A method of preparing polyurethane or polyisocyanurate foam compositions comprising reacting and foaming a mixture of at least one polyol and isocyanate which react to form polyurethane or polyisocyanurate foams in the presence of a blowing agents which comprises:
a hydrofluorocarbon or at least one compound selected from the group consisting of: propane, n-butane, isobutene, n-pentane, isopentane, neopentane, cyclopentane, acetone, dimethyl ether, and inert gases;
an acid; and
optionally, water.

16. The method according to claim 15, wherein said hydrofluorocarbon is present in an amount between about 1 to 99 weight percent based on the amount of said method, said acid is present in an amount between about 1 to 99 weight percent based on the amount of said method, and said water is present in an amount between about 0 to 98 weight percent based on the amount of said method.

17. The method according to claim 16, wherein said hydrofluorocarbon is present in an amount between about 40 to 95 weight percent based on the amount of said method, said acid is present in an amount between about 5 to 60 weight percent based on the amount of said method, and said water is present in an amount between about 0 to 20 weight percent based on the amount of said method.

18. The method according to claim 17, wherein said hydrofluorocarbon is present in an amount between about 70 to 90 weight percent based on the amount of said method, said acid is present in an amount between about 10 to 30 weight percent based on the amount of said method, and said water is present in an amount between about 0 to 5 weight percent based on the amount of said method.

19. The method according to claim 15, wherein said hydrofluorocarbon is at least one selected from the group consisting of: pentafluoropropane isomers (HFC-245), difluoromethane (HFC-32); difluoroethane isomers (HFC-152); trifluoroethane (HFC-143); tetrafluoroethane isomers (HFC-134); pentafluoroethane isomers (HFC-125); hexafluoropropane isomers (HFC-236); heptafluoropropane isomers (HFC-227); pentafluorobutane isomers (HFC-365); fluoroethane isomers (HFC-161); difluoropropane isomers (HFC-272); trifluoropropane isomers (HFC-263); tetrafluoropropane isomers (HFC-254); fluoropropane isomers (HFC-281); hexafluorobutane isomers (HFC-356); decafluoropentane isomers (HFC-43-10mee); chlorodifluoroethane isomers (HCFC-22); dichlorofluoroethane isomers (HCFC-141 b); dichlorotrifluoroethane isomers (HCFC-123); chlorotetrafluoroethane isomers (HCFC-124); perfluoroethane; perfluoropropane; perfluorobutane; perfluorocyclobutane; dichloropropane and difluoropropane.

20. The method according to claim 16, wherein said hydrofluorocarbon is 1,1,1,3,3-pentafluoropropane (HFC-245fa).

21. The method according to claim 15, wherein said acid is at least one acid selected from the group consisting of: mono functional carboxylic acids, di functional carboxylic acids, and hydroxy acids.

22. The method according to claim 15, wherein said acid is formic acid.

23. The method according to claim 15, wherein said blowing agent is present in an amount between about 1 to 60 parts of said blowing agent per 100 parts of said polyol.

24. The method according to claim 23, wherein said blowing agent is present in an amount of between about 5 to 35 parts by weight of said blowing agent per 100 parts by weight of polyol.

25. A closed cell polyurethane or polyisocyanurate foam composition prepared from a polymer foam formulation comprising a blowing agent composition comprising:
a hydrofluorocarbon or at least one compound selected from the group consisting of: propane, n-butane, isobutene, n-pentane, isopentane, neopentane, cyclopentane, acetone, dimethyl ether, and inert gases;
an acid; and
optionally, water.

26. A premix of a polyol and a blowing agent wherein said blowing agent comprises:
a hydrofluorocarbon or at least one compound selected from the group consisting of: propane, n-butane, isobutene, n-pentane, isopentane, neopentane, cyclopentane, acetone, dimethyl ether, and inert gases;
an acid; and
optionally, water.
